(19) United States
(12) Patent Application Publication
(10) Pub. No.: US 2024/0378692 A1
(43) Pub. Date: Nov. 14, 2024

(54) METHOD FOR WATERMARK EXTRACTION, COMPUTER DEVICE AND STORAGE MEDIUM

(71) Applicant: Beijing Volcano Engine Technology Co., Ltd., Beijing (CN)

(72) Inventors: Feng GUO, Beijing (CN); Hengchang GUO, Beijing (CN); Junwei LUO, Beijing (CN); Xiaodong SU, Beijing (CN); Minglei LI, Beijing (CN)

(21) Appl. No.: 18/660,871

(22) Filed: May 10, 2024

(30) Foreign Application Priority Data
May 12, 2023 (CN) 202310540488.6

(51) Int. Cl. G06T 1/00; G06V 10/40; G06V 10/774

(52) U.S. Cl. CPC G06T 1/005; G06V 10/40; G06V 10/774

(57) ABSTRACT

A method and apparatus for watermark extraction, a computer device and a storage medium are provided. The method includes: acquiring an image to be detected; inputting the image to be detected into a watermark recognition network and acquiring a watermark detection result corresponding to the image to be detected; and when the watermark detection result includes presence of a hidden watermark, extracting the hidden watermark in the image to be detected based on at least one extraction algorithm corresponding to the watermark detection result.

### CROSS-REFERENCE TO RELATED APPLICATION

This application claims the priority to and benefits of the Chinese Patent Application, No. 202310540488.6, which was filed on May 12, 2023. The aforementioned patent application is hereby incorporated by reference in its entirety.

### TECHNICAL FIELD

The present disclosure relates to the field of computer technology, and in particular to a method and apparatus for watermark extraction, a computer device and a storage medium.

### BACKGROUND

With the improvement of copyright awareness, more and more users add watermarks to their works before publishing the works (e.g., videos, pictures, etc.). At present, in addition to directly superimposing the watermark directly on the work, there are a plurality of watermark generation techniques that can generate hidden watermarks with higher security and concealment, such as a spatial domain algorithm and a frequency domain algorithm. Usually, in order to verify a creator of a work, it is necessary to extract the watermark from the work.

In the related art, when extracting the hidden watermark, a plurality of extraction algorithms corresponding to the generation algorithm of the hidden watermark are usually set in advance, and the hidden watermark in the work is extracted by sequentially attempting each of the extraction algorithms. However, if this method is adopted, for any work, a plurality of watermark extraction algorithms need to be executed sequentially to extract the watermark, leading to consumption of a large amount of time and the reduction of watermark extraction efficiency.

### SUMMARY

At least one embodiment of the present disclosure provides a method and apparatus for watermark extraction, a computer device and a storage medium.

At least one embodiment of the present disclosure provides a method for watermark extraction, which includes:
acquiring an image to be detected;
inputting the image to be detected into a watermark recognition network and acquiring a watermark detection result corresponding to the image to be detected; and
when the watermark detection result includes presence of a hidden watermark, extracting the hidden watermark in the image to be detected based on at least one extraction algorithm corresponding to the watermark detection result.

In a possible embodiment, the watermark detection result includes an identification of at least one target generation algorithm, and the target generation algorithm is used for generating the hidden watermark in the image to be detected;
the inputting the image to be detected into a watermark recognition network and acquiring a watermark detection result corresponding to the image to be detected includes:
inputting the image to be detected into the watermark recognition network to obtain at least one confidence level corresponding to at least one generation algorithm outputted by the watermark recognition network, where the at least one confidence level corresponding to the at least one generation algorithm is used for characterizing a probability that the hidden watermark in the image to be detected is generated based on the at least one generation algorithm; and
taking an identification of a generation algorithm, a confidence level corresponding to which is greater than a preset threshold, as the identification of the target generation algorithm included in the watermark detection result.

In a possible embodiment, the watermark recognition network determines a plurality of confidence levels corresponding to a plurality of generation algorithms based on the following methods:
extracting feature images with a plurality of sizes corresponding to the image to be detected; and
determining the plurality of confidence levels corresponding to the plurality of generation algorithms based on the feature images with the plurality of sizes.

In a possible embodiment, the taking an identification of a generation algorithm, a confidence level corresponding to which is greater than a preset threshold, as the identification of the target generation algorithm included in the watermark detection result includes:
determining candidate generation algorithms, confidence levels corresponding to which are greater than the preset threshold; and
when the number of candidate generation algorithms exceeds a preset number, among the candidate generation algorithms, determining identifications of the preset number of target generation algorithms, confidence levels corresponding to which meet a preset condition.

In a possible embodiment, the watermark recognition network is obtained through training in a plurality of training stages, sample data used in different training stages is sample data obtained by processing based on different data enhancement methods, a complexity of a data enhancement method corresponding to sample data used in a current training stage is higher than a complexity of a data enhancement method in a previous training stage of the current training stage.

In a possible embodiment, the method further includes training the watermark recognition network, including:
acquiring sample data carrying a watermark label in a plurality of training stages, where the watermark label is used for characterizing an identification of a generation algorithm for generating a hidden watermark of the sample data;
for a current training stage, inputting sample data of the current training stage into an intermediate recognition network obtained after a training in a previous training stage of the current training stage is completed to obtain an output result of the intermediate recognition network, where sample data of a first training stage is inputted into an initial recognition network; and
based on a watermark label carried by the sample data in the current training stage and the output result, training the intermediate recognition network obtained after the training in the previous training stage of the current training stage is completed.

In a possible embodiment, the plurality of training stages include a first training stage for data enhancement processing based on a pixel level, a second training stage for data enhancement processing based on geometric transformation, and a third training stage for data enhancement processing based on both the pixel level and the geometric transformation.

In a possible embodiment, a data enhancement processing in the third training stage further includes image fusion.

In a possible embodiment, the sample data includes video images and non-video images, and hidden watermarks of the video images and the non-video images are generated based on a video watermark generation algorithm and/or an image watermark generation algorithm.

At least one embodiment of the present disclosure further provides an apparatus for watermark extraction, which includes:
an acquisition module configured to acquire an image to be detected;
a determination module configured to input the image to be detected into a watermark recognition network and acquire a watermark detection result corresponding to the image to be detected; and
an extraction module configured to, when the watermark detection result includes presence of a hidden watermark, extract the hidden watermark in the image to be detected based on at least one extraction algorithm corresponding to the watermark detection result.

In a possible embodiment, the watermark detection result includes an identification of at least one target generation algorithm, and the target generation algorithm is used for generating the hidden watermark in the image to be detected;
the determination module, when inputting the image to be detected into a watermark recognition network and acquiring a watermark detection result corresponding to the image to be detected, is configured to:
input the image to be detected into the watermark recognition network to obtain at least one confidence level corresponding to at least one generation algorithm outputted by the watermark recognition network, where the at least one confidence level corresponding to the at least one generation algorithm is used for characterizing a probability that the hidden watermark in the image to be detected is generated based on the at least one generation algorithm; and
take an identification of a generation algorithm, a confidence level corresponding to which is greater than a preset threshold, as the identification of the target generation algorithm included in the watermark detection result.

In a possible embodiment, the watermark recognition network determines a plurality of confidence levels corresponding to a plurality of generation algorithms based on the following methods:
extracting feature images with a plurality of sizes corresponding to the image to be detected; and
determining the plurality of confidence levels corresponding to the plurality of generation algorithms based on the feature images with the plurality of sizes.

In a possible embodiment, the determination module, when taking an identification of a generation algorithm, a confidence level corresponding to which is greater than a preset threshold, as the identification of the target generation algorithm included in the watermark detection result, is configured to:
determine candidate generation algorithms, confidence levels corresponding to which are greater than the preset threshold; and
when the number of candidate generation algorithms exceeds a preset number, among the candidate generation algorithms, determine identifications of the preset number of target generation algorithms, confidence levels corresponding to which meet a preset condition.

In a possible embodiment, the watermark recognition network is obtained through training in a plurality of training stages, sample data used in different training stages is sample data obtained by processing based on different data enhancement methods, a complexity of a data enhancement method corresponding to sample data used in a current training stage is higher than a complexity of a data enhancement method in a previous training stage of the current training stage.

In a possible embodiment, the apparatus further includes a training module, and the training module is configured to train the watermark recognition network according to the following methods:
acquiring sample data carrying a watermark label in a plurality of training stages, where the watermark label is used for characterizing an identification of a generation algorithm for generating a hidden watermark of the sample data;
for a current training stage, inputting sample data of the current training stage into an intermediate recognition network obtained after a training in a previous training stage of the current training stage is completed to obtain an output result of the intermediate recognition network, where sample data of a first training stage is inputted into an initial recognition network; and
based on a watermark label carried by the sample data in the current training stage and the output result, training the intermediate recognition network obtained after the training in the previous training stage of the current training stage is completed.

In a possible embodiment, the plurality of training stages include a first training stage for data enhancement processing based on a pixel level, a second training stage for data enhancement processing based on geometric transformation, and a third training stage for data enhancement processing based on both the pixel level and the geometric transformation.

In a possible embodiment, a data enhancement processing in the third training stage further includes image fusion.

In a possible embodiment, the sample data includes video images and non-video images, and hidden watermarks of the video images and the non-video images are generated based on a video watermark generation algorithm and/or an image watermark generation algorithm.

At least one embodiment of the present disclosure further provides a computer device, which includes: at least one processor, a memory and a bus, where the memory stores machine-readable instructions executable by the at least one processor; the at least one processor communicates with the memory through the bus upon running of the computer device, and the machine-readable instructions, upon being executed by the at least one processor, execute the method for watermark extraction according to at least one of the above embodiments of the present disclosure.

At least one embodiment of the present disclosure further provides a non-transient computer-readable storage medium which stores computer programs, the computer programs, upon being run by at least one processor, executing the method for watermark extraction according to at least one of the above embodiments of the present disclosure.

In order to make the aforementioned objects, features and advantages of the present disclosure more comprehensible, embodiments accompanied with the drawings are described in detail below.

### BRIEF DESCRIPTION OF DRAWINGS

To more clearly illustrate the embodiments of the present disclosure, the drawings required to be used for the embodiments are briefly described in the following. The drawings herein are incorporated into and form a part of the specification, illustrate embodiments consistent with the present disclosure, and are used in conjunction with the specification to explain the principles of the present disclosure. It should be understood that are only some embodiments of the present disclosure, and therefore should not be regarded as limiting the scope. For those skilled in the art, other drawings can be obtained based on these drawings without any inventive work.

FIG. 1 shows a flowchart of a method for watermark extraction provided by an embodiment of the present disclosure;

FIG. 2 shows a schematic diagram of a structure of a watermark recognition network provided by an embodiment of the present disclosure;

FIG. 3 shows a schematic diagram of a generation flow of sample data provided by an embodiment of the present disclosure;

FIG. 4 shows a flowchart of a specific training method of a watermark recognition network provided by an embodiment of the present disclosure;

FIG. 5 shows a flowchart of a specific method for watermark extraction provided by an embodiment of the present disclosure;

FIG. 6 shows an architectural schematic diagram of an apparatus for watermark extraction provided by an embodiment of the present disclosure; and

FIG. 7 shows a structural schematic diagram of a computer device provided by an embodiment of the present disclosure.

### DETAILED DESCRIPTION

To make the objects, technical solutions and advantages of the present disclosure clearer, the technical solutions of the embodiments of the present disclosure will be described clearly and fully understandable in conjunction with the drawings related to the embodiments of the present disclosure. Apparently, the described embodiments are just a part but not all of the embodiments of the present disclosure. The components in the embodiments of the present disclosure generally described and illustrated in the drawings herein may be arranged and designed in various different configurations. Therefore, the following detailed description of the embodiments of the present disclosure provided in the accompanying drawings is not intended to limit the scope of the claimed disclosure, but merely represents selected embodiments of the present disclosure. Based on the described embodiments herein, those skilled in the art can obtain other embodiment(s), without any inventive work, which should be within the scope of the present disclosure.

With the improvement of copyright awareness, more and more users add watermarks to their works before publishing the works (e.g., videos, pictures, etc.). In order to make the added watermark more secure and hidden, some users may choose to add the hidden watermark to the work. However, if the work is edited (such as cropped, scaled, subjected to color transformation, smoothed and blurred, etc.), the hidden watermarks will be difficult to recognize.

Based on the above research, the present disclosure provides a method and apparatus for watermark extraction, a computer device and a storage medium. After an image to be detected is acquired, the image to be detected may be inputted into a watermark recognition network and a watermark detection result corresponding to the image to be detected is acquired, and then a hidden watermark in the image to be detected is extracted based on at least one extraction algorithm corresponding to the watermark detection result when the watermark detection result includes the hidden watermark. In this way, the hidden watermarks do not need to be extracted by sequentially executing a plurality of watermark extraction algorithms, and the hidden watermarks in the image to be detected can be extracted only according to the extraction algorithm corresponding to the watermark detection result, and the efficiency of extracting the hidden watermark is improved.

It should be noted that like reference numbers and letters refer to like items in the following drawings, and thus, once an item is defined in one drawing, it need not be further defined or explained in subsequent drawings.

The term “and/or” herein merely describes an associative relationship, meaning the presence of three relationships; for example, A and/or B may mean that A exists alone, A and B exist simultaneously, and B exists alone. In addition, the term “at least one” herein means any one of a plurality of elements or any combination of at least two of a plurality of elements, for example, including at least one of A, B, C may mean including any one or more elements selected from the group consisting of A, B and C.

It can be understood that before using the technical solutions disclosed in various embodiments of the present disclosure, users should be informed of the types, scope of use, use scenarios, etc. of personal information involved in the present disclosure in an appropriate way according to relevant laws and regulations and be authorized by the users.

For example, in response to receiving an active request from a user, prompt information is sent to the user to clearly prompt the user that an operation requested by the user to be performed will require acquisition and use of personal information of the user. Therefore, the user can independently choose whether to provide personal information to software or hardware such as a computer device, an application program, a server or a storage medium that performs the operations of the technical solution of the present disclosure according to the prompt information.

As an optional but non-limiting implementation, in response to receiving the active request of the user, the prompt information may be sent to the user by, for example, a pop-up window, in which the prompt information can be presented in the form of text. In addition, the pop-up window can also carry a selection control for the user to choose “agree” or “disagree” to provide personal information to the computer device.

It can be understood that the above process of notifying and acquiring user authorization is only schematic, and does not limit the implementation of the present disclosure, and other ways meeting relevant laws and regulations may also be applied to the implementation of the present disclosure.

In order to facilitate the understanding of this embodiment, a method for watermark extraction disclosed in the embodiment of the present disclosure is first described in detail. An execution subject of the method for watermark extraction provided in the embodiment of the present disclosure is generally a computer device with certain computing power, which is, for example, a client or a server, and the client exemplarily may be a personal computer, a tablet computer, a smartphone, and the like. In some possible implementations, the method for watermark extraction may be realized by at least one processor calling computer-readable instructions stored in a memory.

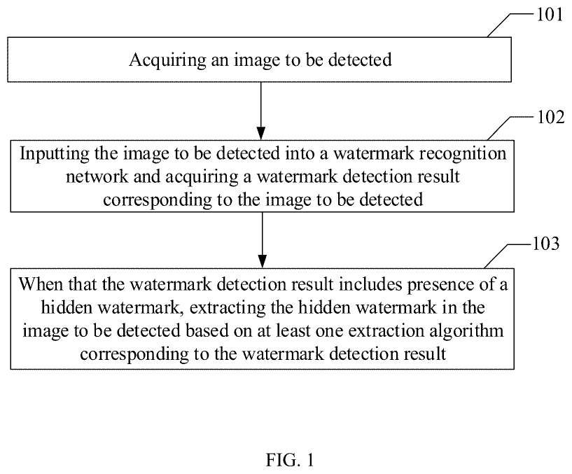

FIG. 1 is a flowchart of a method for watermark extraction provided by an embodiment of the present disclosure, which includes steps 101 to 103.

Step 101: acquiring an image to be detected;

Step 102: inputting the image to be detected into a watermark recognition network and acquiring a watermark detection result corresponding to the image to be detected; and

Step 103: when the watermark detection result includes presence of a hidden watermark, extracting the hidden watermark in the image to be detected based on at least one extraction algorithm corresponding to the watermark detection result.

The following is a detailed description of the above steps.

For step 101,
the image to be detected may be an independent image (or referred to as a non-video image) or may be a video frame (or referred to as a video image) in a video. Specifically, one or more frames may be extracted from any video. The image to be detected may be a watermark-free image, an image including one type of hidden watermark, or an image including a plurality of types of hidden watermarks. For example, after splicing a plurality of images, the spliced image may include hidden watermarks of the plurality of images at the same time. The hidden watermark may be, exemplarily, a watermark generated by algorithms such as a spatial domain algorithm, a frequency domain algorithm, a deep learning algorithm, etc., which is not limited here.

For step 102,
the watermark detection result may include at least one of the following: presence of a hidden watermark or absence of a hidden watermark, an identification of at least one target generation algorithm (the target generation algorithm is used for generating the hidden watermark in the image to be detected, and the identification of the target generation algorithm such as an identification of a generation algorithm 1 is 01), at least one confidence level corresponding to at least one generation algorithm (a confidence level corresponding to a generation algorithm is used for characterizing a probability that the hidden watermark in the image to be detected is generated based on the generation algorithm, for example, the confidence level corresponding to the generation algorithm 1 is 80%, the confidence level corresponding to a generation algorithm 2 is 70%, and the confidence level corresponding to a generation algorithm 3 is 10%), etc. Before the image to be detected is inputted to the watermark recognition network, the size of the image to be detected may be adjusted to a preset size, for example, the image to be detected may be scaled.

In a possible embodiment, the watermark recognition network is obtained by training in a plurality of training stages, sample data used in different training stages is sample data obtained by processing based on different data enhancement methods, a complexity of a data enhancement method corresponding to the sample data used in a current training stage is higher than a complexity of a data enhancement method in a previous training stage of the current training stage.

Specifically, during the training of the watermark recognition network, the complexity of the data enhancement methods corresponding to sample data in the plurality of training stages may be gradually increased, and the learning difficulty and recognition difficulty of the sample data enhanced by the data enhancement method with higher complexity are higher, and if the watermark recognition network is directly trained by the sample data processed by the data enhancement method with high complexity, the network is difficult to converge and the training effect is poor, therefore, the recognition ability of the watermark recognition network may be gradually improved from easy to difficult. Exemplarily, the complexity of scaling is higher than the complexity of sharpening in the data enhancement method, thus the training stage based on the sharpened sample data may be previous to the training stage based on the scaled sample data.

It should be noted that any sample data may be enhanced based on at least one data enhancement method, but it is necessary to avoid mutual interference between the data enhancement methods. For example, after random noise is added to a certain image, the random noise in the image will be weaken if the image is smoothed and blurred additionally.

The sample data may also include sample data without being subjected to data enhancement, which may be used as sample data for the first training stage.

Training the watermark recognition network by adopting the sample data processed by the data enhancement method can improve the training effect of the watermark recognition network and the generalization ability of the watermark recognition network.

In a possible embodiment, in the case that the watermark detection result includes an identification of a target generation algorithm, when the image to be detected is inputted to the watermark recognition network to acquire the watermark detection result corresponding to the image to be detected, the image to be detected may be inputted to the watermark recognition network first to obtain at least one confidence level corresponding to at least one generation algorithm outputted by the watermark recognition network; then, an identification of a generation algorithm, a confidence level corresponding to which is greater than a preset threshold, is taken as the identification of the target generation algorithm included in the watermark detection result.

A plurality of preset thresholds corresponding to a plurality of generation algorithms may be the same or different. The preset thresholds may be determined according to actual test results. For example, according to the test result, when the preset threshold corresponding to the generation algorithm 1 is 80%, a correct rate of judging whether the hidden watermark generated based on generation algorithm 1 is included in the image is the highest, then it is determined the preset threshold corresponding to the generation algorithm 1 is 80%.

Specifically, after the image to be detected is inputted to the watermark recognition network, the watermark recognition network may output a confidence level vector including a plurality of confidence levels corresponding to a plurality of generation algorithms. Then each confidence level in the confidence vector is compared with a corresponding preset threshold, the target generation algorithm, a confidence level corresponding to which is greater than a corresponding preset threshold, is determined, and the identification of the target generation algorithm is added to the watermark detection result.

Exemplarily, if the plurality of confidence levels corresponding to the plurality of generation algorithms outputted by the watermark recognition network is as follows: the confidence level of the generation algorithm 1 is 80%, the confidence level of the generation algorithm 2 is 70%, the confidence level of the generation algorithm 3 is 10%, a confidence level of a generation algorithm 4 is 75%, a confidence level of a generation algorithm 5 is 95%, preset thresholds of the generation algorithms 1 and 2 are 75%, and corresponding preset thresholds of the generation algorithm 3, the generation algorithm 4 and the generation algorithm 5 are 80%, then the generation algorithm 1 and the generation algorithm 5 are target generation algorithms.

In another possible embodiment, when an identification of a generation algorithm, a confidence level corresponding to which is greater than a preset threshold, as the identification of the target generation algorithm included in the watermark detection result, it is possible to first determine candidate generation algorithms, confidence levels corresponding to which are greater than the preset threshold; then, when the number of the candidate generation algorithms exceeds a preset number, among the candidate generation algorithms, identifications of the preset number of target generation algorithms, confidence levels corresponding to which meet a preset condition, are determined.

The plurality of preset thresholds corresponding to the plurality of generation algorithms may be the same or different. The method for determining the preset thresholds is the same as the above-mentioned method for determining the preset thresholds, which is omitted here. The preset number of target generation algorithms, confidence levels corresponding to which meet a preset condition, may be a preset number of target generation algorithms with highest confidence levels, or a preset number of target generation algorithms, confidence levels corresponding to which have the largest difference from the preset threshold, and the preset number exemplarily may be 3.

Specifically, the plurality of confidence levels corresponding to the plurality of generation algorithms may be compared with the plurality of preset thresholds to determine candidate generation algorithms, confidence levels corresponding to which are greater than the preset threshold, then it is determined whether the number of the candidate generation algorithms exceeds the preset number, if not, the plurality of candidate generation algorithms are taken as the target generation algorithms, if so, among the candidate generation algorithms, the preset number of target generation algorithms, confidence levels corresponding to which meet a preset condition, is determined, and identifications of the target generation algorithms are added to the watermark detection result.

For example, if the plurality of confidence levels corresponding to the plurality of candidate generation algorithms are as follows: the confidence level corresponding to the generation algorithm 1 is 80%, the confidence level corresponding to the generation algorithm 2 is 85%, the confidence level corresponding to the generation algorithm 3 is 90%, the confidence level corresponding to the generation algorithm 4 is 95%, the confidence level corresponding to the generation algorithm 5 is 97%, and the preset number is 2, then the target generation algorithms are the generation algorithm 4 and the generation algorithm 5, and identifications of the generation algorithm 4 and the generation algorithm 5 are added to the watermark detection result.

Because in a practical application, there are usually not too many types of hidden watermarks in any image, and when excessive candidate generation algorithms are detected, only a preset number of candidate generation algorithms with higher confidence levels are selected, which can increase an accuracy rate of determining the target generation algorithms, and which can also reduce the number of determined target generation algorithms. Thus, in step 103, the hidden watermark in the image to be detected can be extracted based on fewer extraction algorithms, which improves the watermark extraction efficiency.

In a possible implementation, when the plurality of confidence levels corresponding to the plurality of generation algorithms are not greater than the plurality of preset thresholds, it can be determined that the watermark detection result is the absence of the hidden watermark.

In a possible embodiment, when the image to be detected is a video image in a target video, a watermark detection result of the target video may be determined based on watermark detection results of a plurality of video images extracted from the target video.

Exemplarily, a plurality of target generation algorithms corresponding to the plurality of video images in the target video may be determined first, and then the same generation algorithm among the plurality of target generation algorithms is taken as the generation algorithm of the hidden watermark of the target video (if the watermark detection results of the video images are absence of the hidden watermark, then the watermark detection result of the target video is the absence of the hidden watermark); or, average confidence levels corresponding to the plurality of generation algorithms of the plurality of video images may be determined, and then the watermark detection result of the target video is determined based on the average confidence levels corresponding to the plurality of generation algorithms and the plurality of preset thresholds corresponding to the plurality of generation algorithms.

The above method for determining the watermark detection result of the target video based on the watermark detection results of the video images is only an example, and the embodiment of the present disclosure is not limited thereto.

In a possible implementation, the watermark recognition network determines the plurality of confidence levels corresponding to the plurality of generation algorithms based on the following steps: extracting feature images with a plurality of sizes corresponding to the image to be detected; and determining the plurality of confidence levels corresponding to the plurality of generation algorithms based on the feature images with the plurality of sizes.

Specifically, the watermark recognition network consists of feature extraction layers at a plurality of depths, and the feature images with the plurality of sizes are respectively extracted through the feature extraction layers at different depths in the watermark recognition network; for example, the feature images with the plurality of sizes include a shallow feature image, a middle feature image and a high feature image, the shallow feature image has a larger size than the middle feature image, and the middle feature image has a larger size than the high feature image.

The image to be detected may be extracted by at least one shallow feature extraction layer to obtain the shallow feature image, then the shallow feature image is extracted based on at least one middle feature extraction layer to obtain the middle feature image, and finally the middle feature image is extracted based on at least one deep feature extraction layer to obtain the high feature image; thereafter, the confidence levels corresponding to the generation algorithms may be determined based on the shallow feature image, the middle feature image and the high feature image.

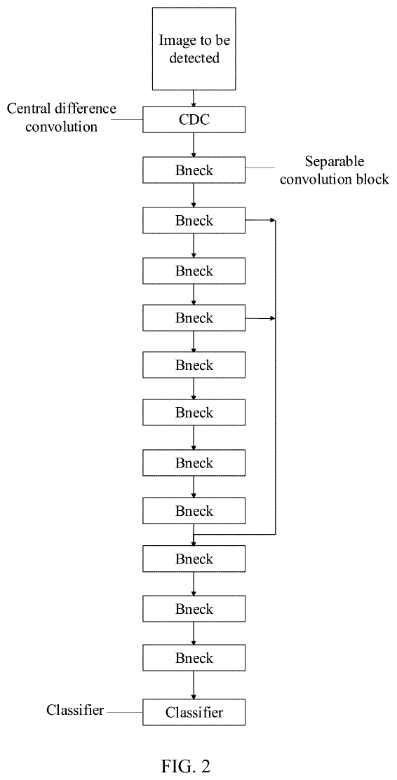

In a specific example, the watermark recognition network may be a convolutional neural network (CNN), for example, the watermark recognition network may be obtained after improvement based on a MobileNet model. Specifically, a structure of the watermark recognition network may be as shown in FIG. 2. In order to improve the extraction ability of the watermark recognition network for the shallow feature image, the shallow feature image of the image to be detected may be extracted by central difference convolution (CDC) and a separable convolution block (Bneck) (of a size of 3×3), the middle feature image of the image to be detected may be extracted by at least one Bneck, and the high feature image of the image to be detected may be extracted by at least one Bneck. FIG. 2 is only an example, and the number of Bneck for extracting feature images at each layer may be adjusted according to actual test results.

In this way, because the hidden watermark does not actually have a high-level semantic feature, the watermark detection result is co-determined in combination with the shallow feature image, the middle feature image and the high feature image, which can improve the accuracy of the watermark detection result.

Then, the watermark detection result of the image to be detected may be determined by a classifier according to the shallow feature, the middle feature and the high feature. The classifier includes a fully connected layer, a pooling layer, an activation function and other structures. As the image to be detected may include a plurality of hidden watermarks generated respectively based on a plurality of generation algorithms, the activation function may be a sigmoid function.

In this way, for any generation algorithm, the confidence level of the algorithm may be outputted by the sigmoid function, and whether the hidden watermark generated by the generation algorithm is included in the image to be detected may be determined by comparing the confidence level corresponding to the generation algorithm with a preset threshold.

In a possible implementation, the watermark recognition network may be trained according to the following steps A1 to A3:

A1: acquiring sample data carrying a watermark label in a plurality of training stages, where the watermark label is used for characterizing the identification of the generation algorithm for generating the hidden watermark of the sample data (for example, the identification of the generation algorithm 1 may be 01).

Specifically, the sample data includes watermarked images and watermark-free images, a watermark label of the watermark-free image may be a preset label (such as 00), and the watermarked image may be generated based on the watermark-free image (i.e. an original data set) and at least one hidden watermark generation algorithm (such as a spatial domain algorithm, a frequency domain algorithm, a deep learning algorithm, etc.).

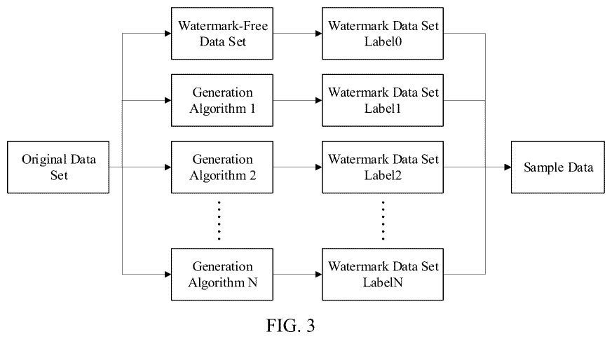

Exemplarily, a generation process of the sample data may be as shown in FIG. 3: firstly, an original data set including no hidden watermarks is acquired, then a preset watermark label “label0” is added to the original data set to obtain a watermark-free data set with the label0, then corresponding watermark data sets are generated for the original data set based on N generation algorithms respectively, and labels are added to the watermark data sets, for example, labelN is added to the Nth watermark data set, and finally the watermark-free data set and the N watermark data sets are taken as the sample data.

In a practical application, multimedia content requiring watermark detection may be a video or an image, that is, the image to be detected may be a video image or a non-video image, thus, in a possible implementation, the sample data may include video images and non-video images, and hidden watermarks of the video images and the non-video images are generated based on a video watermark generation algorithm and/or an image watermark generation algorithm.

Specifically, for a video, hidden watermarks may be added to the video based on the video watermark generation algorithm, and then video frames (i.e., video images) in the video may be extracted, for example, one frame is extracted every preset time or one frame is extracted every preset number of frames, etc., so that the video image added with the hidden watermark is obtained; it is also possible to extract the video frames (video images) in the video first, and then generate hidden watermarks of each of the video images based on the image watermark generation algorithm.

For an image (i.e., a non-video image), the non-video image may be copied for many times to form a video composed of the plurality of non-video images, then hidden watermarks are added to the video based on the video watermark generation algorithm, and finally any of non-video images in the video with the hidden watermarks added is extracted to obtain the non-video image with the hidden watermark added; it is also possible to directly add the hidden watermark to the non-video image based on the image watermark generation algorithm.

In this way, because the acquired sample data includes video images and non-video images with hidden watermarks generated by the video watermark generation algorithm and/or the image watermark generation algorithm, by training the watermark recognition network with the sample data, the generalization ability of the watermark recognition network is improved and the watermark recognition network is enabled to more comprehensively recognize hidden watermarks generated by the video watermark generation algorithm and/or the image watermark generation algorithm.

In a possible implementation, the training stage includes a first training stage for data enhancement processing based on a pixel level, a second training stage for data enhancement processing based on geometric transformation, and a third training stage for data enhancement processing based on both the pixel level and the geometric transformation.

Specifically, training may be performed for different training stages by adopting sample data processed by different data enhancement methods; the sample data in the first training stage may include sample data without being subjected to data enhancement processing and sample data processed by the pixel-level data enhancement method, such as sample data processed based on at least one of the following first data enhancement methods: smoothing and blurring, sharpening, color transformation, JPEG compression, webp compression, random noise, etc. For any sample data, the sample data can be processed based on a first preset number (such as 1) of first data enhancement methods.

Because the complexity of the pixel-level data enhancement method is lower, the watermark recognition network can have a preliminary ability to recognize the hidden watermark generation algorithm by training with the pixel-level data enhancement method first.

The sample data of the second training stage may include sample data processed by the data enhancement method based on geometric transformation, such as sample data processed based on at least one of the following second data enhancement methods: scaling, translation, flipping, affine transformation, random cropping. For any sample data, the sample data may be processed by a second preset number (for example, 3) of second data enhancement methods.

Because the complexity of the data enhancement method based on geometric transformation is higher, the recognition ability of the watermark recognition network for the hidden watermark generation algorithm can be further improved by training with the data enhancement method based on geometric transformation.

The sample data of the third training stage may be sample data processed by the first data enhancement method and the second data enhancement method. In addition, the data enhancement processing in the third training stage may further include image fusion, that is, the sample data of the third training stage may be further processed by using the data enhancement method based on image fusion on the basis of being processed based on the first data enhancement method and the second data enhancement method. The data enhancement method based on image fusion exemplarily includes picture-in-picture, image splicing and image blending. The picture-in-picture is to superimpose at least one image (after adjusted in size) on the other image (the at least one image and the other image may be the same image). The image splicing is to splice at least two images together. The image blending is to blend at least parts of at least two images into one image (for example, to superimpose two images together and adjust the transparency of the upper image to blend the two images). For any sample data, the sample data may be processed based on a third preset number (such as 1) of first data enhancement methods and a fourth preset number (such as 2) of second data enhancement methods (and a fifth preset number of data enhancement methods based on image fusion).

By combining the pixel-level data enhancement method, and the data enhancement methods based on geometric transformation and image fusion, etc., the sample data with very high recognition difficulty can be generated, and by training with the sample data, the finally obtained watermark recognition network can accurately recognize the hidden watermarks of the image after a plurality of editing processes.

A2: for a current training stage, inputting the sample data of the current training stage into an intermediate recognition network obtained after the training in a previous training stage of the current training stage is completed to obtain an output result of the intermediate recognition network, where sample data of a first training stage is inputted into an initial recognition network.

Specifically, the initial recognition network is an untrained watermark recognition network, thus, for the initial training network, training may be performed based on the sample data in the first training stage to obtain an intermediate recognition network obtained after the training in the first training stage is completed; then the intermediate recognition network obtained after the training in the first training stage is completed may be trained with the sample data in the second training stage to obtain an intermediate recognition network obtained after the training in the second training stage is completed; then, the intermediate recognition network obtained after the training in the second training stage is completed is trained with the sample data in the third training stage, and so on; and the watermark recognition network is obtained by gradually training with the sample data in the plurality of training stages.

A3: based on the watermark label carried by the sample data in the current training stage and the output result, training the intermediate recognition network obtained after the training in the previous training stage of the current training stage is completed.

Specifically, a loss value of the current training stage may be calculated based on a binary cross entropy (BCE) loss function, the watermark label and the output result, and the intermediate recognition network (or the initial recognition network) obtained after the training in the previous training stage of the current training stage is completed may be adjusted based on the loss value of the current training stage to obtain an intermediate recognition network (the watermark recognition network for the last training stage) after the training in the current training stage is completed.

For step 103,
specifically, the correspondence between the plurality of generation algorithms and the plurality of extraction algorithms may be preset, and then the extraction algorithm corresponding to the target generation algorithm in the watermark detection result may be found based on the correspondence, and the hidden watermark in the image to be detected is extracted based on the extraction algorithm.

Exemplarily, if the correspondence is as follows: the generation algorithm 1 corresponds to an extraction algorithm 1, the generation algorithm 2 corresponds to an extraction algorithm 2, and the generation algorithm 3 corresponds to an extraction algorithm 3, then the hidden watermarks in the image to be detected may be extracted based on the extraction algorithm 1 and the extraction algorithm 2 after it is determined that the target generation algorithms in the watermark detection result are the generation algorithm 1 and the generation algorithm 2.

After the hidden watermark is extracted, the hidden watermark may be displayed.

In a possible implementation, if the watermark detection result is the absence of the hidden watermark, preset prompt information may be displayed, such as “This image does not include hidden watermarks”.

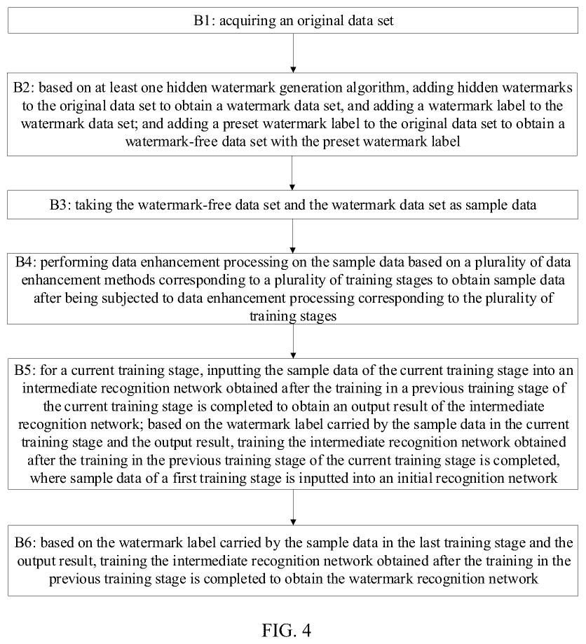

An embodiment of the present disclosure also provides a specific training method for a watermark recognition network, as shown in FIG. 4, including the following steps B1 to B6:
B1: acquiring an original data set;
B2: based on at least one hidden watermark generation algorithm, adding hidden watermarks to the original data set to obtain a watermark data set, and adding a watermark label to the watermark data set; and adding a preset watermark label to the original data set to obtain a watermark-free data set with the preset watermark label;
B3: taking the watermark-free data set and the watermark data set as sample data;
B4: performing data enhancement processing on the sample data based on a plurality of data enhancement methods corresponding to a plurality of training stages to obtain sample data after being subjected to data enhancement processing corresponding to the plurality of training stages;
the sample data described below is sample data after being subjected to data enhancement processing.

B5: for a current training stage, inputting the sample data of the current training stage into an intermediate recognition network obtained after the training in a previous training stage of the current training stage is completed to obtain an output result of the intermediate recognition network; based on the watermark label carried by the sample data in the current training stage and the output result, training the intermediate recognition network obtained after the training in the previous training stage of the current training stage is completed, where sample data of a first training stage is inputted into an initial recognition network; and

B6: based on the watermark label carried by the sample data in the last training stage and the output result, training the intermediate recognition network obtained after the training in the previous training stage is completed to obtain the watermark recognition network.

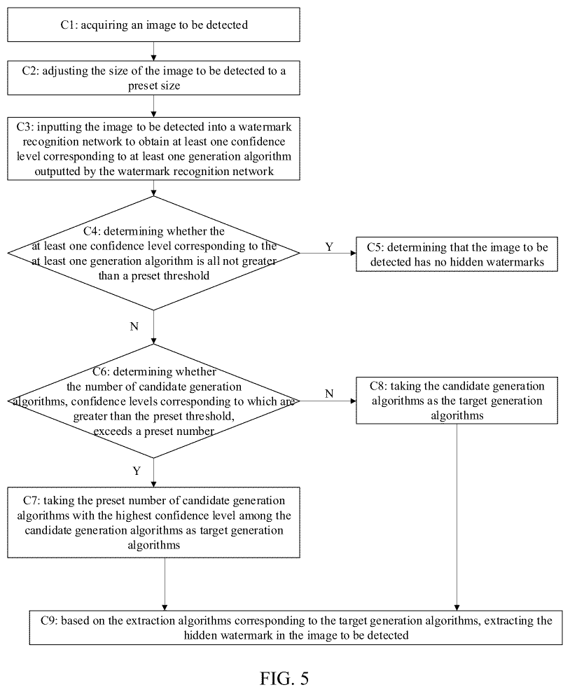

An embodiment of the present disclosure also provides a specific method for watermark extraction, as shown in FIG. 5, including the following steps C1-C9:
C1: acquiring an image to be detected;
C2: adjusting the size of the image to be detected to a preset size;
C3: inputting the image to be detected into a watermark recognition network to obtain at least one confidence level corresponding to at least one generation algorithm outputted by the watermark recognition network;
C4: determining whether the at least one confidence level corresponding to the at least one generation algorithm is all not greater than a preset threshold;
if so, executing step C5; and
if not, executing step C6;
C5: determining that the image to be detected has no hidden watermarks;
C6: determining whether the number of candidate generation algorithms, confidence levels corresponding to which are greater than the preset threshold, exceeds a preset number;
if so, executing step C7; and
if not, executing step C8;
C7: taking the preset number of candidate generation algorithms with the highest confidence level among the candidate generation algorithms as target generation algorithms; and after executing this step, executing step C9;
C8: taking the candidate generation algorithms as the target generation algorithms; and
C9: based on the extraction algorithms corresponding to the target generation algorithms, extracting the hidden watermark in the image to be detected.

According to the method for watermark extraction provided by embodiments of the present disclosure, after an image to be detected is acquired, the image to be detected may be inputted into a watermark recognition network and a watermark detection result corresponding to the image to be detected is acquired, and then when the watermark detection result includes presence of a hidden watermark, the hidden watermark in the image to be detected is extracted based on at least one extraction algorithm corresponding to the watermark detection result. In this way, the hidden watermarks do not need to be extracted by sequentially executing a plurality of watermark extraction algorithms, and the hidden watermarks in the image to be detected can be extracted only according to the extraction algorithm corresponding to the watermark detection result, and the efficiency of extracting the hidden watermarks is improved.

It can be understood by those skilled in the art that in the above-mentioned method of specific implementation, the order in which the steps are written does not imply a strict order of execution which constitutes any limitation to the implementation process, and the exact order in which the steps are executed should be determined by their functions and possible inherent logics.

Based on the same inventive concept, an embodiment of the present disclosure further provides an apparatus for watermark extraction corresponding to the method for watermark extraction. Because the apparatus in the embodiment of the present disclosure has similar principle of solving problems as the above-mentioned method for watermark extraction in the embodiment of the present disclosure, the implementation of the apparatus can refer to the implementation of the method, and the repeated parts are omitted here.

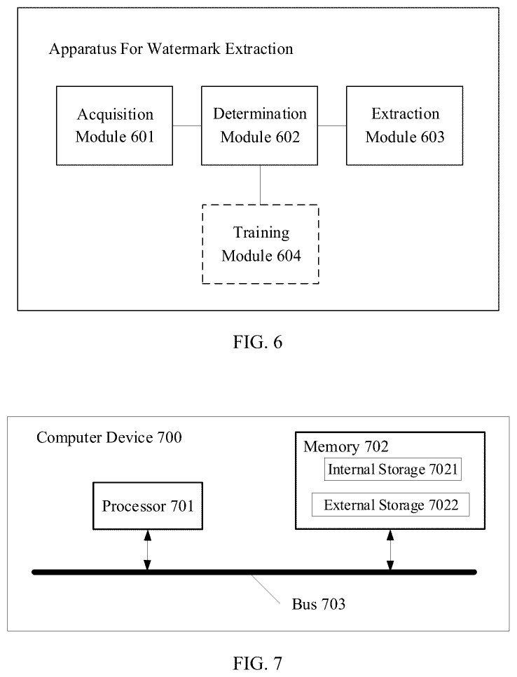

FIG. 6 shows an architectural schematic diagram of an apparatus for watermark extraction provided by an embodiment of the present disclosure. The apparatus includes an acquisition module 601, a determination module 602, an extraction module 603, where
the acquisition module 601 is configured to acquire an image to be detected;
the determination module 602 is configured to input the image to be detected into a watermark recognition network and acquire a watermark detection result corresponding to the image to be detected; and
the extraction module 603 is configured to, when the watermark detection result includes presence of a hidden watermark, extract the hidden watermark in the image to be detected based on at least one extraction algorithm corresponding to the watermark detection result.

In a possible embodiment, the watermark detection result includes an identification of at least one target generation algorithm, and the target generation algorithm is used for generating the hidden watermark in the image to be detected;
the determination module 602, when inputting the image to be detected into a watermark recognition network and acquiring a watermark detection result corresponding to the image to be detected, is configured to:
input the image to be detected into the watermark recognition network to obtain at least one confidence level corresponding to at least one generation algorithm outputted by the watermark recognition network, where the at least one confidence level corresponding to the at least one generation algorithm is used for characterizing a probability that the hidden watermark in the image to be detected is generated based on the at least one generation algorithm; and
take an identification of a generation algorithm, a confidence level corresponding to which is greater than a preset threshold, as the identification of the target generation algorithm included in the watermark detection result.

In a possible embodiment, the watermark recognition network determines a plurality of confidence levels corresponding to a plurality of generation algorithms based on the following methods:
extracting feature images with a plurality of sizes corresponding to the image to be detected; and
determining the plurality of confidence levels corresponding to the plurality of generation algorithms based on the feature images with the plurality of sizes.

In a possible embodiment, the determination module 602, when taking an identification of a generation algorithm, a confidence level corresponding to which is greater than a preset threshold, as the identification of the target generation algorithm included in the watermark detection result, is configured to:
determine candidate generation algorithms, confidence levels corresponding to which are greater than the preset threshold; and
when the number of candidate generation algorithms exceeds a preset number, among the candidate generation algorithms, determine identifications of the preset number of target generation algorithms, confidence levels corresponding to which meet a preset condition.

In a possible embodiment, the watermark recognition network is obtained through training in a plurality of training stages, sample data used in different training stages is sample data obtained by processing based on different data enhancement methods, a complexity of a data enhancement method corresponding to sample data used in a current training stage is higher than a complexity of a data enhancement method in a previous training stage of the current training stage.

In a possible embodiment, the apparatus further includes a training module 604, and the training module 604 is configured to train the watermark recognition network according to the following methods:
acquiring sample data carrying a watermark label in a plurality of training stages, where the watermark label is used for characterizing an identification of a generation algorithm for generating a hidden watermark of the sample data;
for a current training stage, inputting sample data of the current training stage into an intermediate recognition network obtained after a training in a previous training stage of the current training stage is completed to obtain an output result of the intermediate recognition network, where sample data of a first training stage is inputted into an initial recognition network; and
based on a watermark label carried by the sample data in the current training stage and the output result, training the intermediate recognition network obtained after the training in the previous training stage of the current training stage is completed.

In a possible embodiment, the plurality of training stages include a first training stage for data enhancement processing based on a pixel level, a second training stage for data enhancement processing based on geometric transformation, and a third training stage for data enhancement processing based on both the pixel level and the geometric transformation.

In a possible embodiment, a data enhancement processing in the third training stage further includes image fusion.

In a possible embodiment, the sample data includes video images and non-video images, and hidden watermarks of the video images and the non-video images are generated based on a video watermark generation algorithm and/or an image watermark generation algorithm.

The description of the processing flow of the modules in the apparatus, and the interaction flow between the modules can be referred to the relevant descriptions in the method embodiments described above, which will not be described in detail here.

Based on the same technical concept, an embodiment of the present disclosure also provides a computer device. Referring to FIG. 7, it is a structural schematic diagram of a computer device 700 provided by an embodiment of the present disclosure. The computer device includes at least one processor 701, a memory 702, and a bus 703, where the memory 702 is used for storing executable instructions, including an internal storage 7021 and an external storage 7022. The internal storage 7021, also called an internal memory, is used for temporarily storing operation data in the processor 701 and data exchanged with the external storage 7022 such as a hard disk. The processor 701 exchanges data with the external storage 7022 through the internal storage 7021; when the computer device 700 runs, the processor 701 communicates with the memory 702 through the bus 703, causing the processor 701 to execute the following instructions:
acquiring an image to be detected;
inputting the image to be detected into a watermark recognition network and acquiring a watermark detection result corresponding to the image to be detected; and
when the watermark detection result includes presence of a hidden watermark, extracting the hidden watermark in the image to be detected based on at least one extraction algorithm corresponding to the watermark detection result.

In a possible embodiment, the processor 701 executes instructions in which the watermark detection result includes an identification of at least one target generation algorithm, and the target generation algorithm is used for generating the hidden watermark in the image to be detected;
the inputting the image to be detected into a watermark recognition network and acquiring a watermark detection result corresponding to the image to be detected includes:
inputting the image to be detected into the watermark recognition network to obtain at least one confidence level corresponding to at least one generation algorithm, where the at least one confidence level corresponding to the at least one generation algorithm is used for characterizing a probability that the hidden watermark in the image to be detected is generated based on the at least one generation algorithm; and
taking an identification of a generation algorithm, a confidence level corresponding to which is greater than a preset threshold, as the identification of the target generation algorithm included in the watermark detection result.

In one possible embodiment, the processor 701 executes instructions in which the watermark recognition network determines a plurality of confidence levels corresponding to a plurality of generation algorithms based on the following methods:
extracting feature images with a plurality of sizes corresponding to the image to be detected; and
determining the plurality of confidence levels corresponding to the plurality of generation algorithms based on the feature images with the plurality of sizes.

In a possible embodiment, the processor 701 executes instructions in which the taking an identification of a generation algorithm, a confidence level corresponding to which is greater than a preset threshold, as the identification of the target generation algorithm included in the watermark detection result includes:
determining candidate generation algorithms, confidence levels corresponding to which are greater than the preset threshold; and
when the number of candidate generation algorithms exceeds a preset number, among the candidate generation algorithms, determining identifications of the preset number of target generation algorithms, confidence levels corresponding to which meet a preset condition.

In a possible embodiment, the processor 701 executes instructions in which the watermark recognition network is obtained through training in a plurality of training stages, sample data used in different training stages is sample data obtained by processing based on different data enhancement methods, a complexity of a data enhancement method corresponding to sample data used in a training stage is higher than a complexity of a data enhancement method in a previous training stage of the current training stage.

In a possible embodiment, the processor 701 executes instructions in which the method further includes training the watermark recognition network, including:
acquiring sample data carrying a watermark label in a plurality of training stages, where the watermark label is used for characterizing an identification of a generation algorithm for generating a hidden watermark of the sample data;
for a current training stage, inputting sample data of the current training stage into an intermediate recognition network obtained after a training in a previous training stage of the current training stage is completed to obtain an output result of the intermediate recognition network, where sample data of a first training stage is inputted into an initial recognition network; and
based on a watermark label carried by the sample data in the current training stage and the output result, training the intermediate recognition network obtained after the training in the previous training stage of the current training stage is completed.

In a possible embodiment, the processor 701 executes instructions in which the plurality of training stages include a first training stage for data enhancement processing based on a pixel level, a second training stage for data enhancement processing based on geometric transformation, and a third training stage for data enhancement processing based on both the pixel level and the geometric transformation.

In a possible embodiment, the processor 701 executes instructions in which a data enhancement processing in the third training stage further includes image fusion.

In a possible embodiment, the processor 701 executes instructions in which the sample data includes video images and non-video images, and hidden watermarks of the video images and the non-video images are generated based on a video watermark generation algorithm and/or an image watermark generation algorithm.

An embodiment of the present disclosure further provides a computer-readable storage medium storing computer programs, and the computer programs upon being run by at least one processor, execute the steps of the method for watermark extraction described in the foregoing method embodiment. The storage medium may be a volatile or nonvolatile computer-readable storage medium.

An embodiment of the present disclosure further provides a computer program product carrying program codes, the program codes including instructions that can be used to execute the steps of the method for watermark extraction described in the foregoing method embodiment. For details, please refer to the above-mentioned method embodiment, and the details are not repeated here.

The computer program product may be specifically implemented by hardware, software or a combination thereof. In one alternative embodiment, the computer program product is embodied as a computer storage medium, and in another alternative embodiment, the computer program product is embodied as a software product, such as a software development kit (SDK) and the like.

It can be clearly understood by those skilled in the art that, for convenience and simplicity of description, specific working processes of the system and the apparatus described above may refer to the corresponding processes in the foregoing method embodiment, which are omitted here. In the several embodiments provided in the present disclosure, it is to be understood that the disclosed system, apparatus, and method may be implemented in other manners. The above-described apparatus embodiments are merely illustrative. For example, the division of the units may be merely a logical function division, and in actual implementation, there may be another division mode. For another example, multiple units or components may be combined or integrated into another system, or some features may be omitted, or may not be executed. In addition, the displayed or discussed mutual couplings or direct couplings or communication connections may be implemented through some communication interfaces. The indirect couplings or communication connections between the apparatuses or units may be implemented in electronic, mechanical, or other forms.

The units described as separate parts may or may not be physically separate, and the components displayed as units may or may not be physical units, that is, they may be located in one position, or may be distributed on a plurality of network units. Some or all of the units may be selected according to actual needs to achieve the purposes of the solutions of the embodiments.

In addition, functional units in the embodiments of the present disclosure may be integrated into one processing unit, or each unit may exist alone physically, or two or more units may be integrated into one unit.

The functions, if implemented in software functional units and sold or used as a stand-alone product, may be stored in a nonvolatile computer-readable storage medium executable by at least one processor. Based on such understanding, the technical solutions of the present disclosure, which are essential or part of the technical solutions contributing to the related art, may be embodied in the form of a software product, which software product is stored in a storage medium and includes several instructions for causing a computer device (which may be a personal computer, a server, or a network device, etc.) to execute all or part of the steps of the methods described in the embodiments of the present disclosure. The aforementioned storage medium includes a U disk, a mobile hard disk, a read-only memory (ROM), a random access memory (RAM), a magnetic disk or an optical disk and other media that can store program codes.

Finally, it should be noted that the above-mentioned embodiments are merely specific embodiments of the present disclosure, which are used to illustrate the technical solutions of the present disclosure, but not to limit the technical solutions, and the scope of protection of present disclosure is not limited thereto. Although the present disclosure is described in detail with reference to the foregoing embodiments, those of ordinary skill in the art should understand that any person familiar with the art can still make modifications or changes to the embodiments described in the foregoing embodiments, or make equivalent substitutions for some of the technical features, within the technical scope of the present disclosure; and such modifications, changes or substitutions do not make the essence of the corresponding technical solution deviate from the spirit and scope of the technical solutions of the embodiments of the present disclosure, and should be included in the scope of protection of the present disclosure. Therefore, the scope of protection of the present disclosure shall be subject to the scope of protection of the appended claims.

1. A method for watermark extraction, comprising:
acquiring an image to be detected;
inputting the image to be detected into a watermark recognition network and acquiring a watermark detection result corresponding to the image to be detected; and
when the watermark detection result comprises presence of a hidden watermark, extracting the hidden watermark in the image to be detected based on at least one extraction algorithm corresponding to the watermark detection result.

2. The method according to claim 1, wherein the watermark detection result comprises an identification of at least one target generation algorithm, and the target generation algorithm is used for generating the hidden watermark in the image to be detected;
the inputting the image to be detected into a watermark recognition network and acquiring a watermark detection result corresponding to the image to be detected comprises:
inputting the image to be detected into the watermark recognition network to obtain at least one confidence level corresponding to at least one generation algorithm outputted by the watermark recognition network, wherein the at least one confidence level corresponding to the at least one generation algorithm is used for characterizing a probability that the hidden watermark in the image to be detected is generated based on the at least one generation algorithm; and
taking an identification of a generation algorithm, a confidence level corresponding to which is greater than a preset threshold, as the identification of the target generation algorithm comprised in the watermark detection result.

3. The method according to claim 2, wherein the watermark recognition network determines a plurality of confidence levels corresponding to a plurality of generation algorithms based on following methods:
extracting feature images with a plurality of sizes corresponding to the image to be detected; and
determining the plurality of confidence levels corresponding to the plurality of generation algorithms based on the feature images with the plurality of sizes.

4. The method according to claim 2, wherein the taking an identification of a generation algorithm, a confidence level corresponding to which is greater than a preset threshold, as the identification of the target generation algorithm comprised in the watermark detection result comprises:
determining candidate generation algorithms, confidence levels corresponding to which are greater than the preset threshold; and
when a number of candidate generation algorithms exceeds a preset number, among the candidate generation algorithms, determining identifications of the preset number of target generation algorithms, confidence levels corresponding to which meet a preset condition.

5. The method according to claim 1, wherein the watermark recognition network is obtained through training in a plurality of training stages, sample data used in different training stages is sample data obtained by processing based on different data enhancement methods, a complexity of a data enhancement method corresponding to sample data used in a current training stage is higher than a complexity of a data enhancement method in a previous training stage of the current training stage.

6. The method according to claim 1, wherein the method further comprises training the watermark recognition network, comprising:
acquiring sample data carrying a watermark label in a plurality of training stages, wherein the watermark label is used for characterizing an identification of a generation algorithm for generating a hidden watermark of the sample data;
for a current training stage, inputting sample data of the current training stage into an intermediate recognition network obtained after a training in a previous training stage of the current training stage is completed to obtain an output result of the intermediate recognition network, wherein sample data of a first training stage is inputted into an initial recognition network; and
based on a watermark label carried by the sample data in the current training stage and the output result, training the intermediate recognition network obtained after the training in the previous training stage of the current training stage is completed.

7. The method according to claim 5, wherein the plurality of training stages comprise a first training stage for data enhancement processing based on a pixel level, a second training stage for data enhancement processing based on geometric transformation, and a third training stage for data enhancement processing based on both the pixel level and the geometric transformation.

8. The method according to claim 7, wherein a data enhancement processing in the third training stage further comprises image fusion.

9. The method according to claim 6, wherein the sample data comprises video images and non-video images, and hidden watermarks of the video images and the non-video images are generated based on at least one selected from a group consisting of a video watermark generation algorithm and an image watermark generation algorithm.

10. A computer device, comprising:
at least one processor, a memory and a bus, wherein the memory stores machine-readable instructions executable by the at least one processor; the at least one processor communicates with the memory through the bus upon running of the computer device, and the machine-readable instructions, upon being executed by the at least one processor, execute a method for watermark extraction, and the method comprises:
acquiring an image to be detected;
inputting the image to be detected into a watermark recognition network and acquiring a watermark detection result corresponding to the image to be detected; and
when the watermark detection result comprises presence of a hidden watermark, extracting the hidden watermark in the image to be detected based on at least one extraction algorithm corresponding to the watermark detection result.

11. The computer device according to claim 10, wherein the watermark detection result comprises an identification of at least one target generation algorithm, and the target generation algorithm is used for generating the hidden watermark in the image to be detected;
the inputting the image to be detected into a watermark recognition network and acquiring a watermark detection result corresponding to the image to be detected comprises:
inputting the image to be detected into the watermark recognition network to obtain at least one confidence level corresponding to at least one generation algorithm outputted by the watermark recognition network, wherein the at least one confidence level corresponding to the at least one generation algorithm is used for characterizing a probability that the hidden watermark in the image to be detected is generated based on the at least one generation algorithm; and
taking an identification of a generation algorithm, a confidence level corresponding to which is greater than a preset threshold, as the identification of the target generation algorithm comprised in the watermark detection result.

12. The computer device according to claim 11, wherein the watermark recognition network determines a plurality of confidence levels corresponding to a plurality of generation algorithms based on following methods:
extracting feature images with a plurality of sizes corresponding to the image to be detected; and
determining the plurality of confidence levels corresponding to the plurality of generation algorithms based on the feature images with the plurality of sizes.

13. The computer device according to claim 11, wherein the taking an identification of a generation algorithm, a confidence level corresponding to which is greater than a preset threshold, as the identification of the target generation algorithm comprised in the watermark detection result comprises:
determining candidate generation algorithms, confidence levels corresponding to which are greater than the preset threshold; and
when a number of candidate generation algorithms exceeds a preset number, among the candidate generation algorithms, determining identifications of the preset number of target generation algorithms, confidence levels corresponding to which meet a preset condition.

14. The computer device according to claim 10, wherein the watermark recognition network is obtained through training in a plurality of training stages, sample data used in different training stages is sample data obtained by processing based on different data enhancement methods, a complexity of a data enhancement method corresponding to sample data used in a current training stage is higher than a complexity of a data enhancement method in a previous training stage of the current training stage.

15. The computer device according to claim 10, wherein the method further comprises training the watermark recognition network, comprising:
acquiring sample data carrying a watermark label in a plurality of training stages, wherein the watermark label is used for characterizing an identification of a generation algorithm for generating a hidden watermark of the sample data;
for a current training stage, inputting sample data of the current training stage into an intermediate recognition network obtained after a training in a previous training stage of the current training stage is completed to obtain an output result of the intermediate recognition network, wherein sample data of a first training stage is inputted into an initial recognition network; and
based on a watermark label carried by the sample data in the current training stage and the output result, training the intermediate recognition network obtained after the training in the previous training stage of the current training stage is completed.

16. The computer device according to claim 14, wherein the plurality of training stages comprise a first training stage for data enhancement processing based on a pixel level, a second training stage for data enhancement processing based on geometric transformation, and a third training stage for data enhancement processing based on both the pixel level and the geometric transformation.

17. The computer device according to claim 16, wherein a data enhancement processing in the third training stage further comprises image fusion.

18. The computer device according to claim 15, wherein the sample data comprises video images and non-video images, and hidden watermarks of the video images and the non-video images are generated based on at least one selected from a group consisting of a video watermark generation algorithm and an image watermark generation algorithm.

19. A non-transient computer-readable storage medium storing computer programs, wherein the computer programs, upon being run by at least one processor, execute a method for watermark extraction, and the method comprises:
acquiring an image to be detected;
inputting the image to be detected into a watermark recognition network and acquiring a watermark detection result corresponding to the image to be detected; and
when the watermark detection result comprises presence of a hidden watermark, extracting the hidden watermark in the image to be detected based on at least one extraction algorithm corresponding to the watermark detection result.
